(19) United States
(12) Patent Application Publication
(10) Pub. No.: US 2021/0145024 A1
(43) Pub. Date: May 20, 2021

(54) A COLORING COMPOSITION COMPRISING TRICALCIUM PHOSPHATE AS A WHITE COLORING AGENT

(71) Applicant: CHR. HANSEN NATURAL COLORS A/S, Hoersholm (DK)

(72) Inventors: Klaus KOEHLER, Hoersholm (DK); Natarajan PADMANABHAN, Milwaukee, WI (US)

(73) Assignee: CHR. HANSEN NATURAL COLORS A/S, Hoersholm (DK)

(21) Appl. No.: 16/626,299

(22) PCT Filed: Jun. 25, 2018
(86) PCT No.: PCT/EP2018/066876

§ 371 Date: Dec. 23, 2019

(30) Foreign Application Priority Data
Jun. 27, 2017 (EP) 17177997.8

(51) Int. Cl. A23K 20/179; A23K 20/20; A23L 5/43; A23L 29/00

(52) U.S. Cl. CPC A23K 20/179; A23L 29/015; A23L 5/43; A23K 20/20

(57) ABSTRACT

A coloring composition comprising tricalcium phosphate as a coloring agent. It may be used in the manufacture of food, pet food and pharmaceutical products.

### FIELD OF THE INVENTION

The present invention relates to a white coloring composition comprising tricalcium phosphate as a white coloring agent. It may be used in the manufacture of food, pet food and pharmaceutical products and especially for canned food and pet food.

### BACKGROUND ART

Today titanium dioxide is the most widely used white coloring agent in food, pet food and pharmaceutical products because of its great whitening power.

Titanium dioxide is e.g. used for pan coating of confectionary products in order to make a white coating.

Recently there have been some concerns regarding the use of titanium dioxide as a white coloring agent in edible products. According to research published in Environmental Science and Technology, up to 36% of the titanium dioxide found in nearly 90 food products is of nanoparticle variety (Phys.org Mar. 12, 2015).

It is known that titanium dioxide nanoparticles are capable of moving from the lungs or gastrointestinal tract to other organs (Particle and Fibre Toxicology, Apr. 15, 2013). Furthermore animal studies indicate significant accumulation of titanium dioxide nanoparticles in the brain, while toxicity studies have shown the titanium dioxide particles to have a negative effect on brain cell viability and function. The researchers believe exposure to the particles may lead to neurological dysfunction (Nanoscale, 2015 Nov. 28; 7(44):18477-88). Due to these findings there could be negative consumer “feelings” in relation to the use of titanium dioxide for human consumption.

Formulations based on calcium carbonate are sometimes being used as alternatives to titanium dioxide for white coloring. Use of such calcium carbonate based formulations is, however, associated with some disadvantages; at neutral and acid pH applications calcium carbonate may dissolve which can lead to loss of coloring power and gas production. Especially during heat treatment of food and pet food products it has proven to be a problem to use calcium carbonate due to change in color and for canned food and pet food, besides an issue with change in color when heat treated, the combination of pH and temperature may lead to dissolution of calcium carbonate in the cans, which results in gas formation, whereby the cans are swelling.

Further the alkaline reaction of calcium carbonate may lead to interactions with pH-sensitive colors like anthocyanins

There is thus an industrial need for alternative methods for white coloring of food, pet food and pharmaceutical products without any hazardous effects and further for food, pet food and pharmaceutical products at neutral to low pH.

### SUMMARY OF THE INVENTION

It is an object of the present invention to provide a white coloring composition that is not using titanium dioxide or calcium carbonate as the pigment, but still gives an acceptable white coloring of the product of interest such as e.g. pet food, pet treats, chewing gum or chocolate lentils without giving rise to change in color when heat treated and/or which does not result in gas formation when canned.

It is further an object of the present invention to provide a readily water dispersible composition comprising tricalcium phosphate.

Another object of the present invention is providing a coloring composition which remains stable during periods of prolonged storage using tricalcium phosphate for coloring of edible products.

Additionally, it is an object of the present invention to provide a method for coloring edible products, with a white coloring composition comprising tricalcium phosphate.

Tricalcium phosphate is known as a dietary supplement and as an anticaking agent but is mainly used in food products to increase the amount of calcium, it has previously not been selected for coloring products white, but it has now surprisingly been found that the use of tricalcium phosphate gives a convincing white color when added to edible products. As an additional finding is has been found that the composition of the present invention does not form gas when present in canned food or canned pet food.

Further it has been found that the composition of the present invention does not change or loose color when the colored product is heat treated. As an additional finding it has surprisingly been found that the composition of the present invention does not interact with anthocyanin colors causing color shift when these colors are used for panning of chocolate lentils on top of a sugar layer colored with a composition according to the invention.

One advantage of using tricalcium phosphate instead of titanium dioxide as a white coloring agent is that no known health concerns are associated with tricalcium phosphate.

Accordingly, as compared to titanium dioxide there should not be any negative consumer “feelings” in relation to use of tricalcium phosphate as coloring agent in e.g. edible confectionary products.

Further, as compared with calcium carbonate no pH related reactions occurs when using tricalcium phosphate which gives more stable formulations.

A first aspect of the present invention relates to a coloring composition comprising tricalcium phosphate.

A second aspect of the present invention relates to a coloring composition comprising tricalcium phosphate and a dispersing agent.

A third aspect of the present invention relates to a coloring composition comprising tricalcium phosphate and polysorbate.

A fourth aspect of the present invention relates to a method for preparing a coloring composition according to the first aspect of the invention; the method comprising the steps of:

a) mixing tricalcium phosphate and a dispersing agent and water to form an aqueous suspension; and

b) drying the composition.

A fifth aspect of the present invention relates to a method for coloring edible products, such as food, pet food and/or pharmaceutical products, the method comprising the steps of providing a core comprising the edible product, and coating the core with the coloring composition of the invention.

A sixth aspect of the present invention is directed to a food, pet food, pet treat and/or pharmaceutical composition comprising the coloring composition of the present invention.

### Definitions

All definitions of herein relevant terms are in accordance with what would be understood by the skilled person in relation to the herein relevant technical context.

Readily Water Dispersible

That a composition according to the present invention is readily water dispersible means that it should easily disperse in water leaving substantially no agglomerated lumps.

This property is tested in the following way: 50 g of the product to be tested is added to 50 grams of demineralized water. The suspension is stirred with a teaspoon for 30 seconds and left for 1 hour. The suspension is characterized as readily water dispersible if the suspension appears smooth and easily stirred.

Food Grade

A material of the present invention which is defined as food grade means that the material should be suitable and safe for human consumption.

Edible Product

An edible product is defined herein as being a food product e.g. a confectionary, a pet food product, pet treat or a pharmaceutical product e.g. being a tablet.

White Coloring Agent

The term “white coloring agent” simply relates to a coloring agent that gives a white color. When used as a coloring agent as described herein tricalcium phosphate will give a white color and the term “white” in relation to the use of tricalcium phosphate as described herein may therefore be seen as merely descriptive—i.e. not a limiting term.

White Coloring

The term “white coloring” in relation to the use of the water dispersible composition as described herein simply relates to the fact that the tricalcium phosphate coloring agent gives a more white appearance when applied to or mixed into the food, pet food or pharmaceutical product.

Percentages

The percentages of the different materials of the coloring composition are calculated as w/w percentage of total composition.

The term “can” means a rigid retortable container, e.g., a metal container such as a metal or metal alloy can, a plastic container, a glass container, and combinations thereof.

The term “canned” means that an edible product such as a food or a pet food is contained in a can.

As used herein, ranges are used herein in shorthand, so as to avoid having to list and describe each and every value within the range. Any appropriate value within the range can be selected, where appropriate, as the upper value, lower value, or the terminus of the range.

As used herein, the singular form of a word includes the plural, and vice versa, unless the context clearly dictates otherwise. Thus, the references “a”, “an”, and “the” are generally inclusive of the plurals of the respective terms. For example, reference to “food composition” or “a method of making a food composition” includes a plurality of such “food compositions” or “methods”. Similarly, the words “comprise”, “comprises”, and “comprising” are to be interpreted inclusively rather than exclusively. Likewise the terms “include”, “including” and or should all be construed to be inclusive, unless such a construction is clearly prohibited from the context.

Measurement of Water Content

The term “water content” is related to the following test method:
1) 2 grams of a sample is weighed into a Pyrex glass petri dish.
2) The sample is dried in an oven for 3 hours at 110° C.
3) The sample is transferred to a desiccator containing an efficient desiccant and left there for about 30 minutes to cool.
4) The sample is weighed again and the “water content” is the loss on drying as of the weight before drying.

Dried Powder

The term “dried powder” is related to the following test method:
1) 2 grams of a powder is weighed into a Pyrex glass petri dish.
2) The powder is dried in an oven for 3 hours at 110° C.
3) The powder is transferred to a desiccator containing an efficient desiccant and left there for about 30 minutes to cool.
4) The powder is weighed again and the loss on drying is calculated as % of the weight before drying
5) If the loss on drying is less than 10% the powder is characterized as dried

### DETAILED DESCRIPTION OF THE INVENTION

The inventors of the present invention have surprisingly found that tricalcium phosphate can be successfully used as a coloring agent in food, pet food and pharmaceutical products.

The coloring composition of the present invention comprises tricalcium phosphate and optionally a dispersing agent. It has further been found that the composition of the present invention is particularly useful for use in canned food and canned pet food as the coloring composition does not form gas during storage of the canned products or during heat treatment. The formation of gas in canned food and canned pet food can be a major problem for the manufacturers. Further it has been shown that the color of the canned food/pet food does not change color during heat treatment or during storage.

Further it is possible to obtain an improved whitening power of tricalcium phosphate when adding a dispersing agent to tricalcium phosphate.

In a particular embodiment of the present invention the coloring composition relates to a coloring composition comprising tricalcium phosphate and optionally a dispersing agent.

In a more particular embodiment of the present invention the invention relates to a coloring composition comprising tricalcium phosphate, a dispersing agent and optionally water and nothing else.

In an even more particular embodiment of the present invention the invention relates to a coloring composition comprising tricalcium phosphate and polysorbate.

In a further particular embodiment the present invention relates to a coloring composition comprising at least 50% tricalcium phosphate, between 1% and 20% dispersing agent and less than 10% water.

In a further embodiment of the present invention the invention relates to a method for preparing the coloring composition of the invention, wherein said preparation comprises the steps of
a) Mixing a dispersing agent with water until the dispersing agent has dissolved;
b) mixing tricalcium phosphate with the composition of a); and
c) drying the composition of b).

A further embodiment of the present invention relates to the use of the composition of the invention for coloring an edible product.

An even further embodiment of the present invention relates to a method for coloring edible products, such as food, pet food, pet treats and/or pharmaceutical products, the method comprising:
a) providing a core comprising the food product and/or pharmaceutical product and coating the core with the coloring composition of the invention; and/or
b) mixing the coloring composition with a food, pet food and/or a pet treat; and
c) optionally canning the food and/or pet food composition of b); and
d) optionally heat treating the cans of c).

In a preferred embodiment the present invention is directed to an edible composition comprising the coloring composition of the invention.

An even more preferred embodiment of the present invention is directed to canned food and/or pet food comprising the coloring composition of the invention.

Coloring Composition

The coloring composition of the present invention comprises tricalcium phosphate and optionally a dispersing agent. In a preferred embodiment of the present invention the coloring composition is readily water dispersible. In a more preferred embodiment of the present invention the coloring composition comprises tricalcium phosphate and a dispersing agent.

In a particular embodiment the invention relates to a coloring composition comprising at least 50%, 60%, 70%, 75%, 80%, 85%, 90%, 92%, 95%, 98%, 99% of tricalcium phosphate, particularly between 50 to 100%, 60 to 100%, 70 to 100%, 75 to 100%, 80 to 100%, 85 to 100%, 90 to 100% of tricalcium phosphate

In a preferred embodiment the invention relates to a coloring composition comprising at least 50%, 60%, 70%, 75%, 80%, 85%, 90%, 92%, 95%, 98%, 99% of tricalcium phosphate, particularly between 50 to 99%, 60 to 99%, 70 to 99%, 75 to 99%, 80 to 99%, 85 to 99%, 90 to 99% of tricalcium phosphate and at least 1%, 2%, 3%, 4%, 5%, 6%, 7%, 8%, 9%, 10%, 11%, 12%, 13%, 14%, 15%, 16%, 17%, 18, 19%, 20% of dispersing agent such as less than 30%, 25%, 24%, 23%, 22%, 21%, 20%, 19%, 18%, 17%, 16%, 15% of dispersing agent, particularly between 2 to 30%, 4 to 25%, 5 to 20%, 7 to 15% of dispersing agent. In a further preferred embodiment of the present invention the coloring composition comprises less than 10%, 9%, 8%, 7%, 6%, 5%, 4%, 3% water. In a particular embodiment of the present invention the readily water dispersible coloring composition is a dried powder.

In a particular embodiment of the present invention the coloring composition comprises 50 to 99% tricalcium phosphate, 1 to 30% dispersing agent and less than 10% water.

In a particular embodiment of the present invention the coloring composition comprises 60 to 98% tricalcium phosphate, 2 to 25% dispersing agent and less than 8% water.

In a particular embodiment of the present invention the coloring composition comprises 75 to 98% tricalcium phosphate, 4 to 20% dispersing agent and less than 7% water.

In a particular embodiment of the present invention the coloring composition comprises 85 to 98% tricalcium phosphate, 5 to 18% dispersing agent and less than 6% water.

In a particular embodiment of the present invention the coloring composition comprises 50 to 99% tricalcium phosphate particles with a mean particle diameter of less than 10 μm, 1 to 30% dispersing agent and less than 10% water.

In a particular embodiment of the present invention the coloring composition comprises 60 to 98% tricalcium phosphate particles with a mean particle diameter of less than 10 μm, 2 to 25% dispersing agent and less than 8% water.

In a particular embodiment of the present invention the coloring composition comprises 75 to 95% tricalcium phosphate particles with a mean particle diameter of less than 10 μm, 5 to 20% dispersing agent and less than 7% water.

In a particular embodiment of the present invention the coloring composition comprises 85 to 93% tricalcium phosphate particles with a mean particle diameter of less than 10 μm, 7 to 15% dispersing agent and less than 6% water.

Besides the tricalcium phosphate and the dispersing agent the coloring composition as described herein may of course comprise other relevant materials/additives such as but not limited to antioxidants, preservatives and/or other coloring agents.

In a particular embodiment of the present invention the composition is readily water dispersible.

In a particular embodiment the coloring composition is a powder or a liquid.

Tricalcium Phosphate

The coloring agent to be used in the present invention can be any food grade and/or pharmaceutically acceptable tricalcium phosphate. In a particular embodiment of the present invention the tricalcium phosphate is food grade. Tricalcium phosphate is regarded as a safe food additive, and it is believed that there are no hazardous effects related to the use of tricalcium phosphate as a coloring agent in food, pet food and pharmaceuticals.

Chemically, tricalcium phosphate, (Ca₃(PO₄)₂, is a calcium salt of phosphoric acid. Its primary known function in food products is to increase the calcium content.

Tricalcium phosphate is almost insoluble in water. The chalky texture of tri-calcium phosphate makes it useful as a free-flowing agent, as it has the ability to take up 10% of its own weight in moisture. It is relatively inert and does not form complexes or make unwanted reactions such as calcium carbonate when present in alkaline environments.

The E-number of Tricalcium phosphate's is E341(iii), a subclass of calcium phosphates. The CAS Number of tricalcium phosphate is 7758-87-4.

It is also known as tribasic calcium phosphate, tricalcium orthophosphate, and precipitated calcium phosphate and is often abbreviated TCP.

Due to its mineral source, it can be used in vegan foods and is also allowed in organic products.

To be able to give an efficient coloring effect, the mean particle size of the TCP is preferably 10 μm or below.

In a preferred embodiment of the present invention the mean particle diameter of the tricalcium phosphate particles is less than 10 μm, such as less than 9 μm, such as less than 8 μm, such as less than 7 μm, such as less than 6 μm, such as less than 5 μm, such as less than 4 μm, such as less than 3 μm.

In a further particular embodiment of the present invention the mean particle diameter of the tricalcium phosphate particles is less than 2 μm, such as less than 1.5 μm, such as less than 1.0 μm, such as less than 0.5 μm, such as less than 0.3 μm.

The mean particle diameter should be determined by use of laser diffraction by use of for example a Malvern MasterSizer apparatus and using D(4,3) as a measure of the mean particle size. As known in the art D(4,3) relates to the diameter of a spherical particle with the same volume as the actual particle

Accordingly and as understood by the skilled person in the present context, the mean size of the particles relates to D(4,3) measured on a Malvern MasterSizer.

Dispersing Agents

The dispersing agents particularly suitable in the present invention are hydrocolloids and high HLB emulsifiers.

Particularly suitable hydrocolloids may be but are not limited to modified starches such as n-octenyl succinate starch derivative (nOSA starches E1450), hydrolyzed gelatin, gum arabic, maltodextrin and/or beet pectin.

HLB (Hydrophile-Lipophile Balance) is an empirical expression for the relationship of the hydrophilic and hydrophobic groups of emulsifiers. The higher the HLB value, the more water soluble the emulsifier.

In a particular embodiment of the present invention the dispersing agent is selected from emulsifiers having a HLB value above 10. In a more particular embodiment they have an HLB value above 12. In a most particular embodiment the dispersing agents of the present invention have a HLB value above 14.

Particularly suitable emulsifiers may be but are not limited to polysorbates, sucrose esters of fatty acids, E473 and/or polyglycerol esters of fatty acids, E475.

In a particular embodiment of the present invention the dispersing agent is selected from but not limited to modified starches such as n-octenyl succinate starch derivative, hydrolyzed gelatin, gum arabic, maltodextrin, beet pectin, polysorbates, sucrose esters of fatty acids and/or polyglycerol esters of fatty acids.

In a preferred embodiment of the present invention the dispersing agent is a polysorbate and/or a nOSA starch.

Polysorbate

The polysorbate to be used in the present invention can be any food grade or pharmaceutically acceptable polysorbate. In a particular embodiment of the present invention the polysorbate of the invention is food grade.

Polysorbates are oily liquids derived from ethoxylated sorbitan (a derivative of sorbitol) esterified with fatty acids. They are produced by reacting the polyol, sorbitol, with ethylene oxide. The number in the name of the polysorbate indicates the average number of moles of ethylene oxide that has been reacted per mole of sorbitol. The polyoxyethylenated sorbitan is then reacted with fatty acids obtained from vegetable fats and oils such as lauric acid, palmitic acid, stearic acid and oleic acid.

Polysorbates are normally used as dispersing agents and function to disperse oil in water.

The polysorbate may be any polysorbate. In a particular embodiment of the present invention the polysorbate is selected from but not limited to the group of polysorbate 20 (polyoxyethylene sorbitan monolaurate), polysorbate 40 (Polyoxyethylene sorbitan monopalmitate), polysorbate 60, 61 (polyoxyethylene sorbitan monostearate), polysorbate 80, 81 (polyoxyethylene sorbitan monooleate), polysorbate 85 (polyoxyethylene sorbitan monotrioleate) and/or a mixture of any of these.

In a particular coloring composition of the present invention the polysorbate is selected from polysorbate 40, 60, 61 80, 81, 85, between 40 to 85 and/or a mixture of any of these. In a more particular embodiment the polysorbates is selected from polysorbate 60, 61, 80, 81, 85 between 60 to 85 and/or a mixture of any of these. In a most particular embodiment of the present invention the polysorbates is selected from polysorbate 60, 80, 85 and/or a mixture of these.

The most preferred polysorbates of the invention are polysorbate 60 and 80.

Common and commercially available polysorbates are sold under the trade names Scattics®, Alkest®, Canarcel® and Tween®.

Suitable examples of polysorbates include polysorbates with the E-numbers E 432, E 433, E 434, E 435 and E 436.

As known in the art E-numbers are codes for substances that can be used as food additives for use within the European Union and the E-numbers are not changed over time. E-numbers therefore directly and unambiguously technically define a food additive of interest.

In a particular embodiment of the present invention the dispersing agent used in the composition is polysorbate but the composition may comprise other types of dispersing agents than polysorbate. However, in a particular embodiment it is preferred that at least 80% of the total amount of dispersing agent in composition is polysorbate, more preferably that at least 90% of the total amount of dispersing agent in the composition is polysorbate, even more preferably that at least 97% of the total amount of dispersing agent in the composition is polysorbate and most preferably that all of the total amount of dispersing agent in the composition is polysorbate.

nOSA Starch

Starch octenyl succinate is the common name given to starch n-octenyl succinate which is made by treating a starch with n-octenyl succinic anhydride.

Starch octenyl succinate derivatives have the common E number E1450.

A Method for Preparing the Coloring Composition

The present invention further relates to a method for preparing the composition as described herein.

If a dispersing agent is used the method to prepare the coloring composition of the present invention is comprising the preparation of a suspension of tricalcium phosphate by mixing the dispersing agent with tricalcium phosphate.

After mixing the materials the composition is dried if water is used. Normally it happens in a spray dryer. However any drying methods known in the art may be used.

In a particular embodiment of the present invention the water content in the coloring composition is reduced to below 10%, 9%, 8%, 7%, 6%, 5%, 4%, 3% such as below 2%.

In a particular embodiment of the present invention the coloring composition is prepared by:
a) Mixing a dispersing agent with water until the dispersing agent has dissolved;
b) mixing tricalcium phosphate with the composition of a); and
c) drying the composition of b).

The mixing of the materials may be done in any order; however a preferred order is the mixing of water and dispersing agent before mixing with tricalcium phosphate wetted with water:
a) Mixing a dispersing agent with water (blend 1) until the dispersing agent has dissolved;
b) mixing tricalcium phosphate with water (blend 2) until all tricalcium phosphate has been wetted; and
c) mixing blend 1 and 2.

In a preferred embodiment of the present invention the coloring composition is prepared by:
a) adding a dispersing agent to water;
b) mixing the composition of a) until all dispersing agent has dissolved;
c) adding tricalcium phosphate to the composition of b);
d) mixing the composition of c); and
e) drying the composition of d).

A more preferred embodiment of the present invention is a method for preparing a coloring composition, said method comprising the steps of:
a) adding polysorbate to water;
b) mixing the composition of a);
c) adding tricalcium phosphate to water
d) mixing the composition of c); and
e) adding the composition of b) to the composition of d); and
f) drying the composition of e).

Use of the Coloring Composition

The coloring composition of the invention is particularly intended for white coloring of food, pet food, pet treats and/or pharmaceutical products.

In a particular embodiment of the present invention the coloring composition of the present invention is used for coloring food, pet food, pet treats and/or pharmaceutical products.

In a particular embodiment the coloring composition of the present invention is used for coloring products having a pH of below 9, such as below 8, such as below 7, such as below 6. In a more particular embodiment the composition is used for coloring products having a pH in the range of 1 to 9, such as in the range of 2 to 8, such as in the range 3 to 7, such as in the range 4 to 7.

In a particular embodiment the coloring composition of the invention comprising tricalcium phosphate and optionally a dispersing agent is used for white coloring of confectionary products e.g. chocolate lentils and chewing gum.

In a further embodiment the coloring composition comprising tricalcium phosphate and optionally a dispersing agent is used for white coloring of a pharmaceutical product e.g. a tablet.

The coloring composition of the present invention may be applied to an edible product by any conventional method known in the art e.g. by panning, spraying and/or mixing.

In a preferred embodiment of the present invention a food and/or pharmaceutical product is coated with the coloring composition of the invention comprising tricalcium phosphate and optionally a dispersing agent by a panning process.

The process of pan coating also called panning involves building up a coating of a coating agent/film forming agent such as sugar or a sugar alcohol and sometimes of other materials, layer by layer around the outside of a core (e.g. a chewing gum base or almonds) by spraying a liquid comprising the coating agent/film forming agent onto the cores in a specially designed panning machine, wherein the coloring composition comprising tricalcium phosphate and optionally a dispersing agent is added to the liquid before spraying it onto the cores.

For products like chewing gum the coloring composition of the invention applied to the chewing gum may often be the final outer layer of the chewing gum giving the final white color. Whereas if the product is chocolate lentils the coating comprising the coloring composition of the invention is often a layer on which the final color (e.g. a blue color) is applied, but it can also be the final layer. In pet food the coloring agent is often mixed directly into the pet food or pet treats.

A suitable coating agent/film forming agent of the invention may be selected from but are not limited to sugar, sugar alcohols, hydroxy propyl methylcellulose, methyl acrylate-methacrylate acid copolymers and/or polyvinyl acetate phthalate.

Before applying the coloring composition of the invention to an edible product, the coloring composition may be dispersed in a suitable liquid. In a particular embodiment of the present invention the suitable liquid is selected from but not limited to water based solutions of sugar, sugar alcohols, hydroxy propyl methylcellulose, methyl acrylatemethacrylate acid copolymers and/or polyvinyl acetate phthalate.

In a particular embodiment of the present invention the coloring agent is added to a food product, pet food and/or pet treats as a powder or a liquid.

In a particular embodiment of the present invention the coloring composition is applied in a food, pet food and/or pet treats. In a more particular embodiment of the present invention the food and/or pet food is a canned.

A particular embodiment of the invention is directed to a method for coloring edible products, such as food, pet food, pet treats and/or pharmaceutical products, the method comprising the steps of:

a) providing a core comprising the food product and/or pharmaceutical product and coating the core with the coloring composition of the invention; and/or b) mixing the coloring composition with food, pet food and/or pet treat.

The canned food or pet food product may be heat treated. In a particular embodiment the cans are heat treated at a temperature above 90° C., such as above 100° C., such as above 110° C., such as above 120° C. In a particular embodiment the cans are autoclaved.

In a particular embodiment the food and/or pet food product has a pH below 9, such as below 8, such as below 7, such as below 6, such as below 5, such as below 4.

In a particular embodiment of the present invention the pigment is not encapsulated.

In a particular embodiment of the present invention the ratio (w/w) of dispersing agent:tricalcium phosphate is in the range of 1:100 to 1:3, more preferably in the range of 1:50 to 1:4.

The following items are preferred embodiments of the present invention:

Item 1. A coloring composition for use in edible products comprising at least 50% tricalcium phosphate, wherein the mean particle size of TCP is 10 μm or below.

Item 2. The coloring composition of item 1 comprising at least 50% w/w tricalcium phosphate and at least 1% w/w of dispersing agent.

Item 3. A coloring composition only comprising tricalcium phosphate, a dispersing agent and optionally water.

Item 4. The composition of any of the preceding items, wherein the composition is a dried powder.

Item 5. The composition of any of the preceding items, wherein the composition comprises less than 10% w/w of water.

Item 6. The composition of any of the preceding items, wherein the amount of tricalcium phosphate is at least 60%.

Item 7. The composition of any of the preceding items, wherein the amount of tricalcium phosphate is at least 75%.

Item 8. The composition of any of the preceding items, wherein the amount of tricalcium phosphate is at least 85%.

Item 9. The composition of any of the preceding items, wherein the amount of dispersing agent is at least 2%.

Item 10. The composition of any of the preceding items, wherein the amount of dispersing agent is at least 5%.

Item 11. The composition of any of the preceding items, wherein the amount of dispersing agent is at least 7%.

Item 12. The composition of any of the preceding items wherein the tricalcium phosphate is in the range of 60 to 99% and the dispersing agent is in the range of 1 to 30%.

Item 13. The composition of any of the preceding items wherein the tricalcium phosphate is in the range of 75 to 98% and the dispersing agent is in the range of 2 to 25%.

Item 14. The composition of any of the preceding items wherein the tricalcium phosphate is in the range of 80 to 95% and the dispersing agent is in the range of 5 to 20%.

Item 15. The composition of any of the preceding items, wherein the tricalcium phosphate particles have a mean particle diameter of less than 10 μm.

Item 16. The composition of any of the preceding items, wherein the tricalcium phosphate particles have a mean particle diameter of less than 7 μm.

Item 17. The composition of any of the preceding items, wherein the tricalcium phosphate particles have a mean particle diameter of less than 5 μm.

Item 18. The composition of any of the preceding items, wherein the tricalcium phosphate particles have a mean particle diameter of less than 4 μm, less than 3 μm such as less than 2 μm.

Item 19. The coloring composition of any of the preceding items, wherein the dispersing agent is selected from the group consisting of sucrose esters of fatty acids, polyglycerol esters of fatty acids, malto dextrines, hydrolyzed gelatins, gum arabic, or modified starches.

Item 20. The coloring composition of any of item 19, wherein the dispersing agent is a polysorbate.

Item 21. The coloring composition of item 20, wherein the modified starch is a nOSA starch.

Item 22. The composition of any of the preceding items, wherein the polysorbate is selected from the group of polysorbate 40, 60, 61, 80, 81, 85, 40 to 85 and/or any mixtures thereof.

Item 23. The composition of any of the items 1 to 22, wherein the polysorbate is selected from the group of polysorbate 60, 80, 85 and/or any mixtures thereof.

Item 24. The composition of any of the preceding items, wherein the ratio (w/w) of dispersing agent:tricalcium phosphate is in the range of 1:100 to 1:3.

Item 25. The composition of any of the preceding items, wherein the composition is readily water dispersible.

Item 26. A method for preparing the composition of any of the preceding items, said method comprising the steps of
a) Mixing a dispersing agent with water until the dispersing agent has dissolved;
b) mixing tricalcium phosphate with the composition of a); and
c) drying the composition of b).

Item 27. A method for preparing the composition of any of items 1 to 25, said method comprising the steps of
a) Mixing a dispersing agent with water (blend 1) until the dispersing agent has dissolved;
b) mixing tricalcium phosphate with water (blend 2) until all tricalcium phosphate has been wetted; and
c) mixing blend 1 and 2.

Item 28. A method for preparing the composition of any of the preceding items 1 to 25, said method comprising the steps of
a) adding dispersing agent to water;
b) mixing the composition of a);
c) adding tricalcium phosphate to water
d) mixing the composition of c);
e) mixing the composition of b) with the composition of d)
f) drying the composition of e).

Item 29. A method for preparing the composition of any of the preceding items 1 to 25, comprising the steps of
a) adding tricalcium phosphate to a dispersing agent
b) stirring or shaking until the dispersing agent is dispersed onto the surface of the tricalcium phosphate

Item 30. A method for coloring edible products, such as food, pet food, pet treats and/or pharmaceutical products, the method comprising:
a) providing a core comprising the food product and/or pharmaceutical product and coating the core with the coloring composition of any of items 1 to 25; and/or
b) mixing the coloring composition of any of items 1 to 25 with a food, pet food and/or a pet treat; and
c) optionally canning the food and/or pet food composition of b); and
d) optionally heat treating the cans of c).

Item 31. Use of the composition of any of the preceding items for coloring of an edible product.

Item 32. The use of item 31, wherein the edible product is a food product, a pet food, a pet treat and/or a pharmaceutical product.

Item 33. The use of item 32, wherein the product is a confectionary product.

Item 34. The use of item 33, wherein the confectionary product is selected from chewing gum, chewable dragees and/or chocolate lentils.

Item 35. The use of item 34, wherein the product is a pharmaceutical tablet product.

Item 36. The use of any of items 33 to 35, wherein the coloring is performed by pan coating.

Item 37. The use of item 36, wherein the use of the composition is done by a panning process by spraying a liquid onto the food and/or pharmaceutical product to be coated in a panning machine, wherein the liquid is comprising the composition of any of items 1 to 25 and a film forming agent selected from the group consisting of sugar, sugar alcohols, hydroxy propyl methylcellulose, methyl acrylate-methacrylate acid copolymers and/or polyvinyl acetate phthalate.

Item 38. The use of item 32, wherein the coloring composition is mixed into a pet food and/or a pet treat.

Item 39, The use of items 32 or 38, wherein the food, pet food and/or pet treat has a pH below 9, such as below 8, such as below 7, such as below 6.

Item 40. An aqueous formulation comprising the composition of any of the items 1 to 25.

Item 41. The aqueous formulation of item 40, further comprising a film forming agent selected from the group consisting of sugar, sugar alcohols, hydroxy propyl methylcellulose, methyl acrylate-methacrylate acid copolymers and/or polyvinyl acetate phthalate.

Item 42. A composition comprising the coloring composition of any of items 1 to 25, and a film forming agent selected from the group consisting of sugar, sugar alcohols, hydroxy propyl methylcellulose, methyl acrylate-methacrylate acid copolymers and/or polyvinyl acetate phthalate.

Item 43. A food or pet food product comprising the coloring composition of any of items 1 to 25.

Item 44. A canned food product comprising the coloring composition of any of items 1 to 25.

Item 45. A canned pet food product and/or pet treat product comprising the coloring composition of any of items 1 to 25.

Item 46. The canned product of items 44 to 45, wherein the canned product has been heat treated.

Item 47. The canned product of item 46, wherein the canned product has been heat treated above 100° C.

Item 48. The canned product of item 46, wherein the canned product has been heat treated above 120° C.

Item 49. The canned product of any of items 44 to 48, wherein the product has a pH below 9.

Item 50. The canned product of item 49, wherein the product has a pH below 8.

Item 51. The canned product of item 49

The invention is further illustrated by the following non limiting examples.

### EXAMPLES

### Example 1

Preparation of 3 Tricalcium Phosphate Formulations

Materials and Methods

Tricalcium phosphate: food grade quality in accordance with E341 iii. Mean particle diameter below 5 microns

Polysorbate 60: food quality in accordance with E 435

A 20% solution of polysorbate 60 was prepared by adding 160 g of polysorbate to 640 g of demineralized water with a temperature of about 40° C. and stirring until all polysorbate 60 had dissolved.

3 spray slurries were prepared as follows:

| | | 20% | |
|---|---|---|---|
| Demineralized | Tricalcium | polysorbate | Composition |
| water | phosphate | 60 solution | of dried product |
| 1787 g | 780 g | 100 g | 97.5% tricalcium |
| | | | phosphate |
| | | | 2.5% polysorbate 60 |
| 1707 g | 760 g | 200 g | 95.0% tricalcium |
| | | | phosphate |
| | | | 5.0% polysorbate 60 |
| 1627 g | 740 g | 300 g | 92.5% tricalcium |
| | | | phosphate |
| | | | 7.5% polysorbate 60 |

The ingredients were mixed in the following order:
1) Demineralized water
2) Tricalcium phosphate
3) 20% polysorbate solutions

After mixing the spray fluids were dried on a conventional spray drier.

Inlet temperature: approx. 200° C.

Outlet temperature: approx. 85° C.

### Example 2

Application of Tricalcium Phosphate Formulations in Pet Food

Objective: To test tricalcium phosphate (TCP) formulations prepared in example 1 in wet canned pet food as replacement for titanium dioxide and calcium carbonate formulations.

Materials and Methods

Pet Food

Beef 77.44%, vegetables 20.26%, special nutrients 2.3% (bone meal, oil, salt, minerals, vitamins).

Nutrients

| | |
|---|---|
| Crude protein (min.) | 15% |
| Crude fat (min.) | 8% |
| Crude fiber (max.) | 1% |
| Moisture (max.) | 73% |
| Ash (max.) | 3% |
| Carbohydrate (calc.) | 2% |

White Colors

| Pigment | dosage |
|---|---|
| TiO₂ | 0.25% |
| Commercial calcium | 2.17% |
| carbonate formulation | |
| (85% CaCO₃) | |
| TCP 92.5% (ex. 1) | 2.00% |
| TCP 95.0% (ex. 1) | 1.95% |
| TCP 97.5% (ex. 1) | 1.90% |

Color Addition

The pigments were added to 85 g of the pet food followed by blending in a food processor. The colored pet food was filled into cans. The cans were sealed using a manually operated seaming machine (Dixie canning Co.)

Autoclaving

The cans were autoclaved using a steam sterilizer (Getinge, 733LS-E NY, USA). Exposure time was 30 minutes and exposure temperature 115° C.

Measurements

pH was measured before and after autoclaving.

Color was measured after autoclaving using a Hunter colorimeter. DE2000 values were used as a measure for color differences between the sample colored with TiO₂ and the actual sample. It was assumed that when DE2000 is below 1 the visual difference is not perceptible, when DE 2000 is between 1 and 2 the visual difference is acceptable and when DE2000 is above 2 the visual difference is unacceptable.

Water activity was measured after autoclaving

Visual Inspection

The autoclaved samples were visually inspected and compared with the sample colored with TiO₂. The color difference was evaluated: Pass/Fail

Results

Visual inspection after autoclaving: No cans had cracks or leaks and all cans were intact with no popped lids.

pH and Water Activities

| | pH before auto- | pH after | Aw at |
|---|---|---|---|
| Sample/color | clave | autoclave | 22.7° C. |
| Uncolored pet food | 6.0 | 6.1 | 0.95 |
| TiO₂ | 6.0 | 6.1 | 0.95 |
| Commercial calcium | 6.0 | 6.2 | 0.95 |
| carbonate formula- | | | |
| tion | | | |
| TCP 92.5% | 6.0 | 6.1 | 0.95 |
| TCP 95.0% | 6.0 | 6.1 | 0.95 |
| TCP 97.5% | 6.0 | 6.1 | 0.95 |

Color Measurements after Autoclave

| | | | | | Visual in- |
|---|---|---|---|---|---|
| | | | | | spection: |
| Sample/color | L | C | h | DE2000 | Pass/Fail |
| TiO2 (refer- | 58.54 | 18.52 | 74.88 | 0.00 | n/a |
| ence) | | | | | |
| Uncolored | 44.95 | 17.42 | 74.36 | 3.55 | Fail |
| Commercial | 45.23 | 19.30 | 73.10 | 3.33 | Fail |
| calcium car- | | | | | |
| bonate for- | | | | | |
| mulation | | | | | |
| TCP 92.5% | 47.51 | 19.60 | 74.77 | 1.18 | Pass |
| TCP 95.0% | 46.93 | 18.95 | 73.59 | 1.68 | Pass |
| TCP 97.5% | 48.92 | 19.81 | 74.42 | 0.83 | Pass |

### CONCLUSION

1) The uncolored sample exhibits an unacceptable large color difference compared to the reference
2) The sample colored with the commercial calcium carbonate formulation also exhibits an unacceptable large color difference compared to the reference
3) All three samples colored with TCP formulations exhibit acceptable color differences when compared to the reference

1. A coloring composition for coloring an edible product, comprising at least 50% w/w of tricalcium phosphate.

2. The coloring composition of claim 1, comprising at least 50% w/w of tricalcium phosphate and at least 1% w/w of dispersing agent.

3. The coloring composition of claim 1, consisting of tricalcium phosphate, a dispersing agent and optionally water.

4. The coloring composition of claim 1, wherein the composition is readily water dispersible.

5. The coloring composition of claim 1, wherein the composition is a dried powder.

6. The coloring composition of claim 1, wherein the composition comprises less than 10% w/w water.

7. The coloring composition of claim 1, comprising at least 75% w/w tricalcium phosphate.

8. The coloring composition of claim 1, comprising at least 2% w/w dispersing agent.

9. The coloring composition of claim 1, comprising at least 5% w/w dispersing agent.

10. The coloring composition of claim 1, wherein the tricalcium phosphate comprises tricalcium phosphate particles that have a mean particle diameter of less than 5 μm.

11. The coloring composition of claim 1, wherein the dispersing agent is selected from polysorbate, sucrose esters of fatty acids, poly-glycerol esters of fatty acids, maltodextrins, hydrolyzed gelatins, gum arabic, and modified starches.

12. The coloring composition of claim 11, wherein the dispersing agent is a nOSA starch.

13. The coloring composition of claim 11, wherein the dispersing agent is a polysorbate

14. The coloring composition of claim 13, wherein the polysorbate is selected from polysorbate 60, polysorbate 80, and mixtures thereof.

15. A method for preparing the coloring composition of claim 1, comprising mixing a dispersing agent with tricalcium phosphate.

16. The method of claim 15, comprising:
(a) mixing a dispersing agent with water until the dispersing agent has dissolved;
(b) mixing tricalcium phosphate with the dissolved dispersing agent composition obtained at step (a); and
(c) drying the composition obtained at step (b).

17. A method for coloring an edible product, selected from a method comprising:
(a) providing a core comprising the edible product and coating the core with the coloring composition of claim 1; and
(b) mixing the coloring composition of claim 1 with an edible product, optionally, canning the resulting product into cans, and optionally heat treating the resulting cans.

18-19. (canceled)

20. A canned human food product, pet food product, or pet treat product, comprising the coloring composition of claim 1.

21. (canceled)

22. The canned product of claim 20, wherein the canned product has been heat treated.

23. The canned product of claim 22, wherein the canned product has been heat treated above 100° C.

24. The canned product of claim 20, wherein the product has a pH below 9.

25. The canned product of claim 24, wherein the product has a pH below 8.

26. The method of claim 17, wherein the edible product is selected from human food products, pet food products, pet treat products, and pharmaceutical products
